(19) United States
(12) Patent Application Publication
(10) Pub. No.: US 2010/0130389 A1
(43) Pub. Date: May 27, 2010

(54) Compositions and Methods for Removal of Asphaltenes from a Portion of a Wellbore or Subterranean Formation Using Water-Organic Solvent Emulsion with Non-Polar and Polar Organic Solvents

(76) Inventors: Stephen Charles Lightford, Cumbria (GB); Franco Armesi, Milan (IT); Franco Reynaldi, Milan (IT)

Correspondence Address: Beusse Wolter Sanks Mora & Maire, 390 N. ORANGE AVENUE, SUITE 2500, ORLANDO, FL, 32801, US

(21) Appl. No.: 12/301,146

(22) PCT Filed: Nov. 20, 2006
(86) PCT No.: PCT/IT06/00806

§ 371 Date: Jan. 25, 2010

(30) Foreign Application Priority Data
May 5, 2006 (IT) 2006/000316

(51) Int. Cl. C09K 8/82; C09K 8/68

(52) U.S. Cl. 507/242; 507/203; 507/266

(57) ABSTRACT

Compositions are provided for removing an organic material, especially asphaltenes, from a portion of a wellbore or a subterranean formation. The composition comprises: (A) water; (B) an organic solvent blend further comprising: (i) a non-polar organic solvent; and (ii) at least two polar organic solvents; and (C) a surfactant adapted for forming an emulsion of the organic solvent blend and the water. According to another aspect of the invention, the compositions comprise: (A) water, wherein the water is greater than 25% by volume of the composition; (B) an organic solvent blend further comprising: (i) a non-polar organic solvent; and (ii) a polar organic solvent; and (C) a surfactant adapted for forming an emulsion of the organic solvent blend and the water. Methods are provided for removing an organic material from a portion of a wellbore or a subterranean formation. The method comprises the steps of: (A) forming a composition according to the invention; and (B) introducing the composition to the portion from which the organic material is to be removed.

### TECHNICAL FIELD

The invention relates to the problem of removing oil-soluble materials such as asphaltenes from a wellbore or subterranean formation.

### BACKGROUND

Asphaltenes are a problem in crude oil production in many areas around the world. Asphaltenes may precipitate in the matrix of the formation, in a previously-created fracture in the formation, in the wellbore, or in production tubing. Asphaltenes that precipitate in the formation can result in plugging of the pores in the matrix subterranean formation. Because asphaltenes have a higher affinity to adsorb on surfaces with a similar structure, that is, on surfaces already with adsorbed asphaltenes, clean up should be as thorough as possible.

Asphaltenes are negligibly soluble in water. Solvents such as toluene and xylene generally dissolve only about 50% of a typical downhole sample of asphaltenes, which has poor solubility parameters in these solvents.

Asphaltenes are known to possess hereto-elements such as N, S, and O in some asphaltene molecules. Such polar sites contribute to asphaltenes adsorbing on rock surfaces.

Both van der Waals forces and polar-polar interactions play a role in the adsorption of asphaltenes onto minerals and rock. The presence of water also affects adsorption of asphaltenes. Water-wet rock exhibits considerable reduction in adsorbed asphaltenes, but the polar constitutions of asphaltenes can penetrate the water film and compete for active sites on the rock surface.

It may not be possible to achieve full desorption of asphaltenes. At best, the rock surface may be changed from oil wet to the range of water wet to intermediate wet. Further, desorption of asphaltenes requires more time than the dissolution of precipitated asphaltenes. However, a full water-wet formation may not be necessary because an intermediate to slightly water-wet formation may be optimum for oil production.

Clean up with pure toluene may remove the majority of the asphaltenes, but the surface on which the asphaltenes are adsorbed will still be covered with a layer of asphaltenes. This layer is likely to be the most polar and highest molecular weight layer, so the rock surface will still be intermediate wet to oil wet. Further, the wettability of a formation can be changed from water wet to oil wet because the toluene can strip water off the rock surface, as the solubility of water in toluene at 100° C. is about 8 times higher than at ambient temperature.

Surfactants can facilitate the dispersion of an organic phase in water. However, a surfactant will not dissolve asphaltenes in water.

### SUMMARY OF THE INVENTION

According to one aspect of the invention, compositions are provided for removing an organic material from a portion of a wellbore, wellbore tubular, fracture system, or matrix of a subterranean formation. The compositions comprise: (A) water; (B) an organic solvent blend further comprising: (i) a non-polar organic solvent; and (ii) at least two polar organic solvents; and (C) a surfactant adapted for forming an emulsion of the organic solvent blend and the water. According to another aspect of the invention, the compositions comprise: (A) water, wherein the water is greater than 25% by volume of the composition; (B) an organic solvent blend further comprising: (i) a non-polar organic solvent; and (ii) a polar organic solvent; and (C) a surfactant adapted for forming an emulsion of the organic solvent blend and the water. Methods are provided for removing an organic material from a portion of a wellbore, wellbore tubular, fracture system, or matrix of a subterranean formation. The methods comprise the steps of (A) forming a composition according to the invention; and (B) introducing the composition to the portion from which the organic material is to be removed.

### DETAILED DESCRIPTION

As used herein, the words “comprise,” “has,” and “include” and all grammatical variations thereof are each intended to have an open, non-limiting meaning that does not exclude additional elements or steps.

A purpose of the invention is to remove asphaltene scales and deposits and leave the formation in a water wet condition to help delay the plugging caused by further asphaltene or paraffin deposition.

Initially, the absorption or dissolution of organic solvent into the asphaltene coating causes the coating to swell and reduces the effective pore diameter, which may cause an increase in pressure required to push fluid through the matrix of a formation. At the point where the organic layer/solvent becomes mobile, the higher viscosity of the mixture can also contribute to an increase in pressure. A pressure effect can, therefore, be anticipated when cleanup commences. As the initial mixture is diluted with more solvent, the viscosity will decrease and the fluid will become more mobile as the cleanup proceeds.

To remove the strongly-adsorbed asphaltenes layer requires an effective solvent blend. The adsorption/desorption is an equilibrium process that requires a considerable amount of time to reach. But the application of a solvent alone will only partly remove the asphaltenes.

To improve the desorption process, components such as water that compete with the asphaltenes for polar sites on the surface are expected to be helpful. The wetting behavior of this component improves the wettability of the formation towards water wet. The stability of the water wetting film depends, for example, on the pH, salinity, and composition of the brine solution. A water-based fluid containing an organic solvent blend with good solvency for asphaltenes should provide a long-lasting effect.

According to one aspect of this invention, a high proportion of water is used in the composition for removing the asphaltenes. This reduces the amount of solvent needed to remove the scale from the wellbore or formation. This greatly reduces the cost of the treatment relative to prior approaches. The water is preferably greater than 25% by volume of the composition, and most preferably, the water is greater than 50% by volume of the composition. Preferably, the water is present up to 75% by volume of the composition, and most preferably up to about 60% by volume of the composition.

The composition is preferably applied as a single fluid treatment without need for pre-treatment or post-treatment of other fluids for asphaltenes removal.

Purposes of making the composition an emulsion include: keeping the formulation together, preventing other emulsions to be formed downhole when the water-containing fluid contacts crude oil, and aiding in the removal of polar components of asphaltenes from a surface, particularly a rock surface.

The compositions and methods of this invention provide the synergy of the combination of the water, non-polar organic solvent, polar organic co-solvents, and surfactant in the action of dissolving the asphaltene scale as quickly as possible and leaving less asphaltene residue.

Preferably, the water further comprises a water-soluble salt.

The organic solvent blend is selected for being effective to substantially dissolve asphaltenes. As well known in the art, the exact composition and nature of asphaltenes can vary widely depending on the source, and it can be desirable to adjust or modify the exact solvent blend and the water-solvent emulsion compositions depending on the source of the asphaltenes. For example, a composition according to the invention can be more particularly adapted for asphaltenes of the types found in Italy or Northern Africa. The organic solvent blend comprises a non-polar organic solvent and a polar organic solvent. Preferably, the organic solvent blend comprises the non-polar organic solvent and the polar organic solvent in the ratio of (a) from about 99.9% to about 90% by volume of the non-polar organic solvent; and (b) from about 0.1% to about 10% by volume of the polar organic solvent. Most preferably, the organic solvent blend comprises the non-polar organic solvent and the polar organic solvent in the ratio of (a) from about 99% to about 95% by volume of the non-polar organic solvent; and (b) from about 1% to about 5% by volume of the polar organic solvent.

Another important consideration in selecting the organic solvent blend is that the components should not be incompatible with the formation fluids to avoid the formation of undesirable precipitates or residues. Other considerations include that the solvent blend should not tend to poison any catalysts used in the refining of the hydrocarbon produced from the well.

The non-polar organic solvent is preferably selected from the group consisting of: aromatic solvents, terpenes, kerosene, diesel, and any combination thereof.

The flash point of the organic solvent blend is an important safety concern. The flash point of each of the organic solvents, whether non-polar or polar, in the organic solvent blend preferably should be greater than 40° C. (104° F.), and more preferably should be greater than 50° C. (122° F.). The flash point of xylene, for example, is only 27° C. (80° F.). The non-polar organic solvent can comprise, for example, a mixture of D-limonene and dipentene, for which some mixtures have a flash point of about 47° C. (117° F.). A more preferable non-polar solvent is a terpene blend that has a flash point of greater than 50° C. (122° F.). Preferably a “heavy aromatic solvent” is used, which is a distillation cut of a crude oil from which light aromatic solvents, such as xylene and toluene, have been previously distilled out.

According to another aspect of the invention, and more preferably, the polar organic solvent comprises at least two different polar organic solvents. The polar organic solvent is preferably selected for its ability to enhance the solubility of asphaltenes in the organic solvent blend relative to the solubility of the asphaltenes in the non-polar organic solvent alone. A suitable polar organic solvent is selected from the group consisting of N-methyl pyrrolidone, which has a high flash point of 92° C. (199° F.), and cyclohexanone, which has an adequately high flash point of 44° C. (111° F.), and any combination thereof in any proportion. More preferably, the combination of these two polar organic solvents unexpectedly resulted in better dissolution of asphaltenes than either of the two solvents alone in the composition. Without being limited by any theoretical explanation, it is believed that the combination of two different polar organic solvents helps dissolve the asphaltenes. Toluene has a reported Snyder polarity index of only about 2.3, and toluene is normally considered to be a non-polar organic solvent. Cyclohexanone has a reported Snyder polarity index of 4.5, and N-methyl pyrrolidone has a reported Snyder polarity index of about 6.5. These polarity indices provide two different intermediate steps in polarity between non-polar solvents, such as toluene, and water, which has a Snyder polarity index of 9. It is believed that using at least two polar organic solvents having substantially different polarities is contributing to the unexpectedly improved results in dissolving asphaltenes. Accordingly, it is believed that other combinations of polar organic solvents will be suitable, especially if the polar organic solvents have substantially different polarities. Accordingly, it is presently believed that each of the polar organic solvents preferably should have a Snyder polarity index between 3 and 7. More preferably, one of the polar organic solvents should have a Snyder polarity index in the range of 3-5 and one of the polar organic solvents should have a Snyder polarity index in the range of 5-7. In another aspect, at least two of the polar organic solvents should have a Snyder polarity indexes that are at least 1.5 polarity index units apart.

The surfactant preferably comprises a water-soluble surfactant. The flash point of the surfactant is also an important consideration. The flash point of the surfactant preferably should be greater than 40° C. (104° F.), and more preferably should be greater than 50° C. (122° F.). “Baraklean” is a suitable example of a blend of water-soluble surfactants and has a flash point above 93° C. (200° F.), which is commercially available from Baroid Fluid Services. “Baraklean NS” or “Baraklean NS plus” are also suitable, being a blend of water-soluble surfactants with a complexing agent. Further, a suitable surfactant can be selected from the group consisting of: ethoxylated alcohols, ethoxylated nonylphenol, and any combination thereof.

The composition can be a weak emulsion or a dispersion. The composition is preferably a water-external emulsion.

Example Test Procedure:
1. Prepare solvent emulsion formulations
2. Prepare various samples of 10 gram of asphaltene.
3. Treat asphaltene sample with 100 cc of the solvent emulsion and put at 75° C. for 60 minutes and agitate for 30 seconds every 10 minutes.
4. Filter with vacuum on filter paper.
5. Dehydrate the filtrate at 75° C. for 5 hours.
6. Evaluate the residue of the sample.

TABLE 1
Solvent Emulsion Formulations A-D

| Component | A | B | C | D |
|---|---|---|---|---|
| Industrial water | 58% | 55% | 55% | 55% |
| Baraklean NS plus | 6% | 6% | 6% | 6% |
| Non-Polor Solvent: | 33% | 33% | 33% | 33% |
| 84.2% solvent naphtha (petroleum), | | | | |
| heavy aromatic; | | | | |
| 9.5% 1-methoxy-2-methylethyl | | | | |
| acetate; | | | | |
| 0.5% 2-methoxy-1-propyl acetate; | | | | |
| 5.8% 1,2,4-trimethylbenzene; | | | | |
| N-Methyl Pyrrolidone | 3% | 6% | — | 3% |
| Cyclohexanone | — | — | 6% | 3% |

TABLE 2
Test Results

| Solvent | Various Asphaltene Samples 1-6 | | | | | |
|---|---|---|---|---|---|---|
| Emulsion | % Residual Solids | | | | | |
| Formulation | 1 | 2 | 3 | 4 | 5 | 6 |
| A | 45.41 | 77.53 | 25.96 | 4.95 | 13.40 | 75.30 |
| B | 18.96 | 75.03 | 0.50 | 1.67 | 0.30 | 37.50 |
| C | 0.76 | 70.23 | 0.28 | 0.51 | 0.20 | 3.10 |
| D | 1.46 | 43.80 | 0.33 | 0.26 | 0.70 | 1.20 |

As can be observed from the test results, asphaltene sample 2 was particularly difficult to dissolve. Increasing the concentration of the N-methyl pyrrolidone from 3% in Formulation A to 6% in formulation B dramatically decreased the residual solids in samples 1, 3, 4, 5, and 6, but provided smaller improvement for the asphaltene sample 2. Changing the polar solvent from 6% N-methyl pyrrolidone in Formulation B to 6% cyclohexanone in Formulation C dramatically decreased the residual solids in asphaltene samples 1 and 6, but only provided smaller improvement for samples 2-4. Finally, using a combination of 3% N-methyl pyrrolidone and 3% cyclohexanone in the solvent emulsion Formulation D provided dramatically and synergistically decreased the residual solids for asphaltene sample 2.

Preferably, the step of forming the composition further comprises the step of: prior to mixing with the solvent blend, mixing the water with the surfactant.

In a batch, the method preferably includes the step of slowly mixing the solvent blend with the mixture of the water and the surfactant under sufficient shear conditions to form an emulsion. In a continuous process, sometimes referred to as being “on the fly,” the method preferably includes the step of mixing a stream of the solvent blend with a stream of the mixture of the water and the surfactant under sufficient shear conditions to form an emulsion.

Preferably, the step of introducing the composition further comprises the step of: placing the composition in the portion of the well to be treated for a sufficient contact time for the organic solvent blend to dissolve a substantial amount of the organic material. More preferably, the method further comprises the step of: after placing the composition, flowing back the composition through the wellbore.

The asphaltene treatment fluid according to the invention using about 60% by volume water and N-methyl pyrrolidone as the polar organic solvent was also tested in a well. About 440 m³ of a composition according to the invention was injected into the well. There was an increase in the injection pressure much higher than expected immediately after the composition started to enter the formation. This is believed to be caused by the initial swelling of the asphaltenes by the organic solvent blend. It is also possible that the increase in the injection pressure is due to a fluid viscosity effect. In any case, this effect is expected to be a useful self-diverting effect. Following the treatment and displacement with nitrogen, the well flowed without pumping and initially produced a very heavy viscous fluid. The final production of the well was almost 400 m³/day. The performance of the composition confirmed the exceptional results seen in the laboratory, and the initial performance of the well after the test treatment with the new treatment fluid exceeded expectations.

1. A composition for removing an organic material from a portion of a wellbore, wellbore tubular, fracture system, or matrix of a subterranean formation, the composition comprising:
(A) water;
(B) an organic solvent blend further comprising:
(i) a non-polar organic solvent; and
(ii) at least two polar organic solvents; and
(C) A surfactant adapted for forming an emulsion of the organic solvent blend and the water.

2. The composition according to claim 1, wherein the water is greater than 25% by volume of the composition.

3. The composition according to claim 1, wherein the water is greater than 50% by volume of the composition.

4. The composition according to claim 1, wherein the water is greater than 75% by volume of the composition.

5. The composition according to claim 1, wherein the organic material to be removed comprises asphaltenes.

6. The composition according to claim 1, wherein the water further comprises a water-soluble salt.

7. The composition according to claim 1, wherein the organic solvent blend is further selected for being effective to substantially dissolve asphaltenes.

8. The composition according to claim 7, wherein the asphaltenes are of the types found in Italy or Northern Africa.

9. The composition according to claim 1, wherein the organic solvent blend comprises the non-polar organic solvent and the polar organic solvent in the ratio of:
(a) from about 99.9% to about 90% by volume of the non-polar organic solvent; and
(b) from about 0.1% to about 10% by volume of the polar organic solvents.

10. The composition according to claim 1, wherein the non-polar organic solvent is selected from the group consisting of aromatic solvents, terpenes, kerosene, diesel, and any combination thereof.

11. The composition according to claim 1, wherein the non-polar organic solvent has a flash point of greater than 40° C. (104° F.).

12. The composition according to claim 1, wherein the non-polar organic solvent has a flash point of greater than 50° C. (122° F.).

13. The composition according to claim 1, wherein each of the polar organic solvents enhances the solubility of asphaltenes in the organic solvent blend relative to the solubility of the asphaltenes in the non-polar organic solvent.

14. The composition according to claim 1, wherein each of the polar organic solvents has a Snyder polarity index between 3 and 7.

15. The composition according to claim 1, wherein one of the at least two polar organic solvents has a Snyder polarity index between 3 and 5, and the other of the at least two polar organic solvents has a Snyder polarity index between 5 and 7.

16. The composition according to claim 1, wherein the at least two polar organic solvents have Snyder polarity indexes that are at least 1.5 polarity index units apart.

17. The composition according to claim 1, wherein each of the polar organic solvents has a flash point of greater than 40° C. (104° F.).

18. The composition according to claim 17, wherein at least one of the polar organic solvents has a flash point of greater than 50° C. (122° F.).

19. The composition according to claim 1, wherein the polar organic solvents comprise N-methyl pyrrolidone and cyclohexanone, in any proportion.

20. The composition according to claim 19, wherein the polar organic solvents comprise a ratio of N-methyl pyrrolidone and cyclohexanone in any relative proportion between 25:75 and 75:25 by weight.

21. The composition according to claim 1, wherein the surfactant comprises a water-soluble surfactant.

22. The composition according to claim 1, wherein the water-soluble surfactant has a flash point of greater than 40° C. (104° F.).

23. The composition according to claim 1, wherein the water-soluble surfactant has a flash point of greater than 50° C. (122° F.).

24. The composition according to claim 1, wherein the surfactant is selected from the group consisting of: ethoxylated alcohols, ethoxylated nonylphenol, and any combination thereof.

25. The composition according to claim 1, wherein the composition is a water-external emulsion.

26. A method for removing an organic material from a portion of a wellbore, wellbore tubular, fracture system, or matrix of a subterranean formation, the method comprising the steps of:
(A) forming a composition comprising:
(i) water;
(ii) an organic solvent blend further comprising:
(a) a non-polar organic solvent; and
(b) at least two polar organic solvents; and
(iii) a surfactant adapted for forming an emulsion of the organic solvent blend and the water; and
(B) introducing the composition to the portion from which the organic material is to be removed.

27. The method according to claim 26, wherein the water is greater than 25% by volume of the composition.

28. The method according to claim 26, wherein the water is greater than 50% by volume of the composition.

29. The method according to claim 26, wherein the water is up to 75% by volume of the composition.

30. The method according to claim 26, wherein the organic material to be removed comprises asphaltenes.

31. The method according to claim 26, wherein the composition further comprises a water-soluble salt.

32. The method according to claim 26, wherein the organic solvent blend is further selected for being effective to substantially dissolve asphaltenes.

33. The method according to claim 26, wherein the asphaltenes are of the types found in Italy or Northern Africa.

34. The method according to claim 26, wherein each of the polar organic solvents enhances the solubility of asphaltenes in the organic solvent blend relative to the solubility of the asphaltenes in the non-polar organic solvent.

35. The method according to claim 26, wherein each of the polar organic solvents has a Snyder polarity index between 3 and 7.

36. The method according to claim 26, wherein one of the at least two polar organic solvents has a Snyder polarity index between 3 and 5, and the other of the at least two polar organic solvents has a Snyder polarity index between 5 and 7.

37. The method according to claim 26, wherein the at least two polar organic solvents have a Snyder polarity indexes that are at least 1.5 polarity index units apart.

38. The method according to claim 26, wherein the polar organic solvents comprise N-methyl pyrrolidone and cyclohexanone, in any proportion.

39. The method according to claim 38, wherein the polar organic solvents comprise N-methyl pyrrolidone and cyclohexanone in any relative proportion between 25:75 and 75:25 by weight.

40. The method according to claim 26, wherein the composition is a water-external emulsion.

41. A composition for removing an organic material from a portion of a wellbore, wellbore tubular, fracture system, or matrix of a subterranean formation, the composition comprising:
(A) water, wherein the water is greater than 25% by volume of the composition;
(B) an organic solvent blend further comprising:
(i) a non-polar organic solvent; and
(ii) a polar organic solvent; and
(C) a surfactant adapted for forming an emulsion of the organic solvent blend and the water.

42-52. (canceled)

53. A method for removing an organic material from a portion of a wellbore, wellbore tubular, fracture system, or matrix of a subterranean formation, the method comprising the steps of:
(A) obtaining a composition of claim 41 and
(B) introducing the composition to the portion from which the organic material is to be removed.
